(19) United States
(12) Patent Application Publication
(10) Pub. No.: US 2014/0105194 A1
(43) Pub. Date: Apr. 17, 2014

(54) METHOD AND APPARATUS FOR MORE EFFICIENT SHARING OF SYNCHRONIZED DIRECT MODE TIMESLOTS

(71) Applicant: MOTOROLA SOLUTIONS, INC., Schaumburg, IL (US)

(72) Inventors: DAVID G. WIATROWSKI, WOODSTOCK, IL (US); THOMAS B. BOHN, MCHENRY, IL (US); HARRY C. MOORE, CARY, IL (US)

(73) Assignee: MOTOROLA SOLUTIONS, INC., Schaumburg, IL (US)

(21) Appl. No.: 13/650,882

(22) Filed: Oct. 12, 2012

(51) Int. Cl. H04W 72/04; H04W 56/00

(52) U.S. Cl. 370/337

(57) ABSTRACT

A method and device for sharing synchronized direct mode time division multiple access (TDMA) timeslots among a plurality of direct mode radios includes monitoring, by a first direct mode radio, other radios' usage of a plurality of available timeslots on a direct mode radio frequency (RF) and, for each received new transmission, storing an indication of the timeslot used by the new transmission and storing a system partitioning identifier associated with the new transmission. Dynamically determining, by the first radio and as a function of the monitoring, a first preferred transmit timeslot determined to be less likely to interfere with the other direct mode radios. Responsive to detecting a request to transmit a new direct mode call, first determining if the first preferred transmit timeslot is available, and if so, transmitting the new call in the first preferred transmit timeslot on the direct mode radio frequency.

### FIELD OF THE DISCLOSURE

The present disclosure relates generally to wireless communications and more particularly to direct mode synchronized timeslot sharing in a time division multiple access (TDMA) system.

### BACKGROUND

The European Telecommunications Standard Institute—Digital Mobile Radio (ETSI-DMR) is a direct digital replacement for analog Private Mobile Radio (PMR). DMR is a scalable system that can be used in unlicensed mode (in a 446.1 to 446.2 MHz band), and in licensed mode, subject to national frequency planning Any of the ETSI standards or specifications referred to herein may be obtained by contacting ETSI at ETSI Secretariat, 650, route des Lucioles, 06921 Sophia-Antipolis Cedex, FRANCE.

DMR promises improved range, higher data rates, more efficient use of spectrum, and improved battery life. Features supported include fast call set-up, calls to groups and individuals, and short data and packet data calls. Supported communications modes include individual calls, group calls, and broadcast calls provided via a direct communication mode among the radios operating within the network. Other important DMR functions such as emergency calls, priority calls, full duplex communications, short data messages, and Internet Protocol (IP)-packet data transmissions are supported as well.

A radio, as used herein, can be mobile and/or fixed equipment that is used to obtain DMR services. Direct mode is a communication technique where any radio can communicate with one or more other radios without the need for any additional infrastructure equipment (e.g. base stations or repeaters). Direct mode operation is in contrast to the conventional repeater mode which is a mode of operation where radios communicate through the additional infrastructure equipment. Direct mode operation, therefore, can provide a more efficient, less costly communication system than repeater mode operation.

The ETSI-DMR standard provides for 6.25e (2:1 TDMA) operation in repeater mode. 6.25e (2:1 TDMA) operation refers to 6.25 Kilohertz (kHz) equivalent spectral efficiency. As there is no restriction on what happens in each timeslot or any restriction on interrelations between them (other than a need to maintain time synchronicity), it is possible to have two entirely separate conversations at the same time between entirely different units over a same RF medium. By this it is possible that two simplex calls can be independently supported in a single 12.5 kHz channel. Of course, different systems with 3:1 or greater timeslot ratios could support 3 or more simultaneous conversations between entirely different units.

In certain 12.5 KHz direct modes of operation, radios may synchronize to a single, perhaps elected, timing leader so that, even in direct mode, the increased timeslot ratios can be used to support multiple simultaneous conversations. An example of such a direct mode timing synchronization method can be found in U.S. patent application Ser. No. 12/760,787, entitled “Method for Synchronizing Direct Mode Time Division Multiple Access (TDMA) Transmissions,” filed with the United States Patent and Trademark Office on Apr. 15, 2010, and incorporated herein by reference in its entirety.

However, even when time synchronized, radios may not be able to use the multiple available timeslots in a resource-efficient manner. For example, consider the communications system landscape 100 of FIG. 1. As shown in the figure, the communications system landscape 100 includes three general direct mode communications systems (e.g., illustrated as separate but partially overlapping geographic regions of operation) illustrated as communications systems A 102, B 104, and C 106. A direct mode communication system is an arbitrary geographic area where radios configured with a same system partitioning identifier are generally considered to operate. Of course, any particular radio may roam within and/or outside of its direct mode communication system (geographic region of operation) as illustrated in FIG. 1. Radios within a direct mode region of operation are considered to be within transmit and receive range of all other radios in the region, and perhaps transmit and/or receive range of radios in adjacent or overlapping regions of operation. Within direct mode communication system A are radios 110 and 112. Within direct mode communication system C 106 are radios 120 and 122. And within direct mode communication system B are radios 130 and 132.

Each direct mode communication system may be a configured service area associated with one or more agencies by a regulatory body or installer, in such a way that co-channel users may be encountered within a direct mode communication system and between adjacent direct mode communication systems. For example, radios 110 and 112 may be assigned to agency A, radios 130 and 132 assigned to a separate agency B, and radios 120 and 122 assigned to another separate agency C, all sharing one or more channels (timeslots) on a single shared direct mode RF frequency. Each agency may configure its radios to identify a corresponding system partitioning identifier that allows each agency's radios to distinguish communications from one another, such as a color code in accordance with a DMR standard (for example, ETSI TS 102 361-1 v2.1.1, April 2012) or a network access code in accordance with an APCO P25 standard (for example, ANSI/TIA-102.BAAA-A (FDMA—Common Air Interface) Sep. 17, 2003), which helps to prevent one agency from hearing or talking to radios belonging to another agency operating in a same, overlapping, or adjacent direct mode communication system. In operation, agency radios may be assigned and/or configured to operate in a same direct mode communication system, a partially overlapping adjacent direct mode communications systems, and/or a non-overlapping direct mode communications systems.

Part of the challenge in assigning time slots within direct mode communication systems and across a direct mode communication system landscape is that all or a subset of radios in each direct mode communication system may be mobile. Over time, radios come into and go out of range of each other, and into and out of range of radios belonging to other agencies, unpredictably. Radios operating within a nearby direct mode communication system, such as those identified by arbitrary direct mode communication system 102-106, are most likely to be in direct communication with each other, while radios operating in an overlapping or adjacent direct mode communication system are less likely to be in direct communication with a radio in the first direct mode communication system, and radios operating in a non-overlapping and/or non-adjacent direct mode communication system are even less likely to be in direct communication with a radio in the first direct mode communication system. Nonetheless, all radios are ultimately affected by timeslot selections being used across the direct mode communication system landscape 100, e.g., in all direct mode communication systems because the selection of timeslots in one direct mode communication system will most likely, at some point, affect the use of same or different timeslots in same, overlapping, or adjacent direct mode communication systems.

For the purposes of one particular example, and as illustrated in FIG. 1, direct mode communication systems A 102 and C 106 are non-overlapping such that radios operating in direct mode communication system A 102 cannot receive and would not interfere with radios operating in direct mode communication system C 106 and vice versa. However, radio 130 operating in an overlapping direct mode communication system between direct mode communication systems A 102 and B 104 could interfere with radios operating in both direct mode communication system A 102 and radios operating in direct mode communication system B 104. Similarly, radio 132 operating in an overlapping direct mode communication system between direct mode communication systems B 104 and C 106 could interfere with radios operating in both direct mode communication system B 104 and radios operating in direct mode communication system C 106.

Assuming the radios 110, 112, 120, 122, 130, and 132 communicate over a single shared RF frequency in accordance with the ETSI-DMR standard with a 2:1 slotting ratio as set forth above, and that all radios in the communications system 100 are timeslot synchronized, a situation may arise that causes inefficient use of the shared RF resources available across the direct mode communications system landscape 100 due to inefficient selection of timeslots for new calls, in accordance with the following scenario. For example, radio 110 in direct mode communication system A 102 may initiate a new direct mode call 114 to radio 112 on timeslot 1 202, as illustrated in the timing diagram 200 of FIG. 2. Timeslot 1 202 includes 1.25 ms guard intervals 210, 212 and a 27.5 ms payload period 214 that includes a sync slot 216. At the same time radio 120 in direct mode communication system C 106, having no knowledge of the direct mode call 114, may initiate a new direct mode call 124 to radio 122 on timeslot 2 204, as illustrated in FIG. 2. Timeslot 2 204 similarly includes 1.25 ms guard intervals 220, 222 and a 27.5 ms payload period 224 that includes a sync slot 226. Timeslots 1 and 2 then repeat in an interleaved manner as illustrated in FIG. 2, including a second timeslot 1 206 for use by direct mode call 114 and another timeslot 2 208 for use by direct mode call 124, repeating in an interleaved manner until one or both calls end.

Given the scenario as set forth above, if either one of radios 130 or 132 attempt to initiate a new direct mode call 134 while direct mode calls 114 and 124 are still active, the call will be unsuccessful due to the lack of available, non-interfering timeslots on the shared RF frequency. In other words, radio 132 cannot use timeslot 2 204, 208 because that would interfere with the direct mode call 124 and cannot use timeslot 1 202, 206, which appears to radio 132 to be available, due to interference at radio 130 generated by call 114 in timeslot 1 202, 206 (e.g., the so-called hidden node problem). Similarly, radio 130 cannot use timeslot 1 202, 206 because that would interfere with the direct mode call 114 and cannot use timeslot 2 204, 208, which appears to radio 130 to be available, due to interference at radio 132 generated by call 124 in timeslot 2 204, 208 (e.g., the hidden node problem). Because of this, radios 130 and 132 will have to delay establishing the new call 134 until either direct mode call 114 ceases or until direct mode call 124 ceases, resulting in negative impacts on performance and user experience at radios 130 and 132 due to inefficient selection of direct mode timeslots.

Accordingly, there is a need to support more spectrally efficient direct mode timeslot selection for 2:1 TDMA or 6.25e direct mode, and other n:1 ratio TDMA communications systems where n>1.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a block diagram of an illustrative wireless direct mode communications system landscape operating in accordance with an embodiment.

FIG. 2 is a transmission diagram illustrating a conventional system's use of direct mode timeslots in the wireless communication system of FIG. 1.

FIG. 3 is a block diagram of an illustrative direct mode radio that may be used in the communication system of FIG. 1 in accordance with an embodiment.

FIG. 4 is a flow diagram of a receive monitoring process that may be implemented at the direct mode radio of FIG. 3 in order to track timeslot usage in surrounding direct mode communication systems of the direct mode radio in accordance with an embodiment.

FIG. 5 is a first part of a flow diagram of a transmit process that may be implemented at the direct mode radio of FIG. 3 in order to use tracked timeslot usage information in order to determine a preferred transmit timeslot for a future communication initiated at the direct mode radio in accordance with an embodiment.

FIG. 6 is a second part of a flow diagram of a transmit process that may be implemented at the direct mode radio of FIG. 3 in order to use tracked timeslot usage information in order to determine a preferred transmit timeslot for a future communication initiated at the direct mode radio in accordance with an embodiment.

FIG. 7 is a transmission diagram illustrating a system's improved use of direct mode timeslots in the wireless communication system of FIG. 1 in accordance with an embodiment.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Disclosed herein is an improved and more spectrally efficient direct mode timeslot selection process and device for 2:1 TDMA or 6.25e direct mode, and other n:1 ratio TDMA communications systems where n>1.

According to a first embodiment of the present disclosure, a method for sharing synchronized direct mode time division multiple access (TDMA) timeslots among a plurality of direct mode radios includes monitoring, by a first direct mode radio, other radios' usage of a plurality of available timeslots on a direct mode radio frequency (RF) and, for each received new transmission, storing an indication of the timeslot used by the new transmission and storing a system partitioning identifier associated with the new transmission. Subsequently, the first direct mode radio dynamically determining as a function of the monitoring, a first preferred transmit timeslot determined to be less likely to interfere with the other direct mode radios. Responsive to detecting a request to transmit a new direct mode call, the first direct mode radio first determining if the first preferred transmit timeslot is available, and if so, transmitting the new call in the first preferred transmit timeslot on the direct mode radio frequency. If the first preferred transmit timeslot is not available, the first direct mode radio determining if another non-preferred transmit timeslot in the plurality of timeslots is available, and if so, transmitting the new call on the non-preferred transmit timeslot on the direct mode radio frequency.

According to a second embodiment of the present disclosure a direct mode radio for synchronizing direct mode time division multiple access (TDMA) timeslots among a plurality of other direct mode radios is disclosed, the direct mode radio configured to monitor other radios' usage of a plurality of available timeslots on a direct mode radio frequency and, for each received new transmission, store an indication of the timeslot used by the new transmission and store a system partitioning identifier associated with the new transmission. Subsequently, the direct mode radio dynamically determines as a function of the monitoring, a first preferred transmit timeslot determined to be less likely to interfere with the other direct mode radios. Responsive to detecting a request to transmit a new direct mode call, the direct mode radio first determines if the first preferred transmit timeslot is available, and if so, transmits the new call in the first preferred transmit timeslot on the direct mode radio frequency. If the first preferred transmit timeslot is not available, the first direct mode radio determines if another non-preferred transmit timeslot in the plurality of timeslots is available, and if so, transmits the new call on the non-preferred transmit timeslot on the direct mode radio frequency.

Each of the above-mentioned embodiments will be discussed in more detail below, starting with example device architecture of a direct mode radio in which the embodiments may be practiced, followed by a discussion of how to dynamically determine a preferred transmit timeslot and use the preferred transmit timeslot in transmitting a new call, from the point of view of a direct mode radio. Further advantages and features consistent with this disclosure will be set forth in the following detailed description, with reference to the figures.

### I. DIRECT MODE RADIO DEVICE ARCHITECTURE

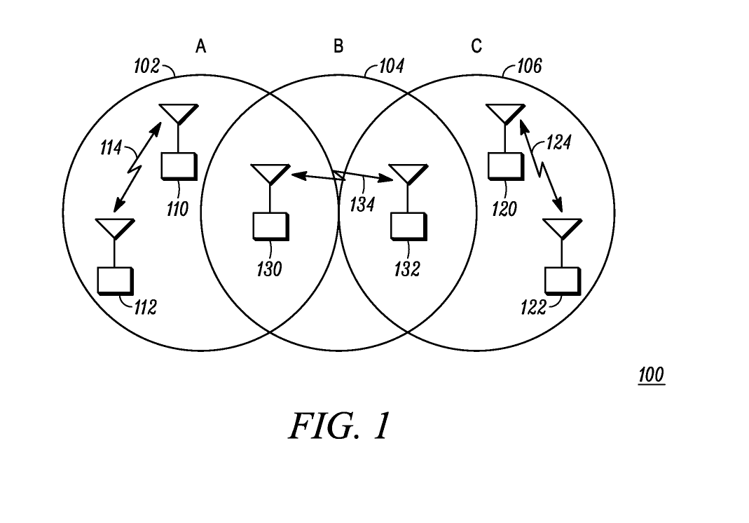

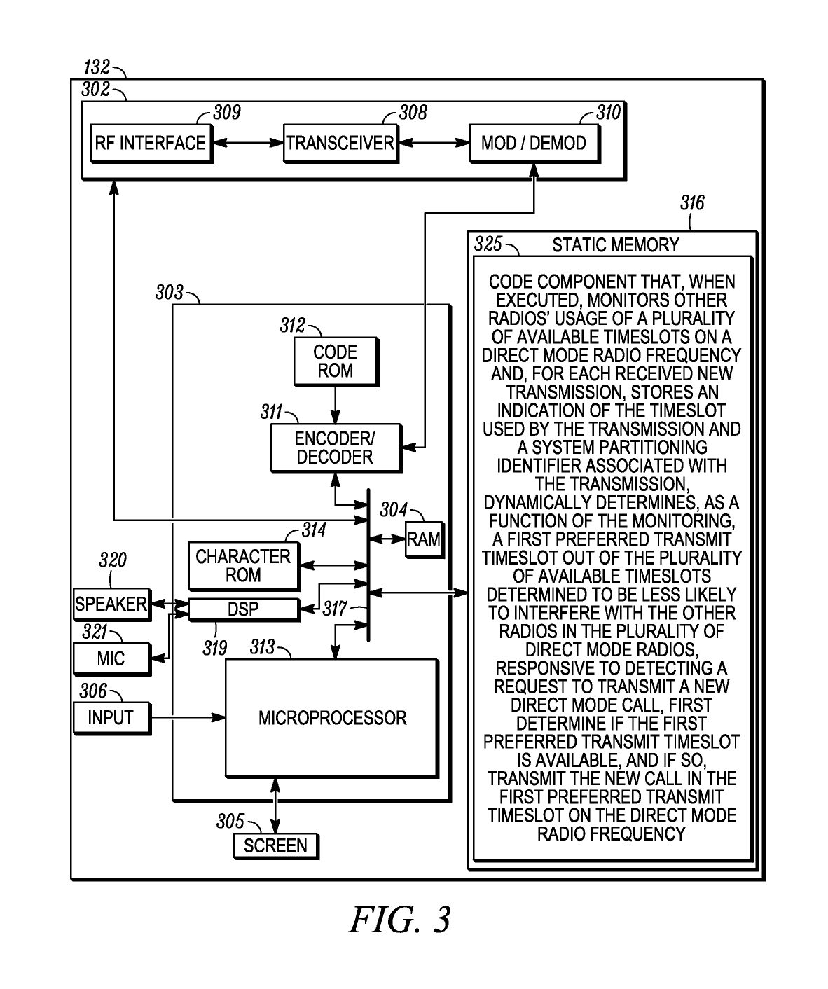

FIG. 3 is an example functional block diagram of a direct mode radio, such as radio 132 operating within the system 100 of FIG. 1 in accordance with some embodiments. Other direct mode radios such as radios 110, 112, 120, 122, and/or 130 may contain same or similar structures. As shown in FIG. 3, radio 132 includes a communications unit 302 coupled to a common data and address bus 317 of a processing unit 303. The radio 132 may also include an input unit (e.g., keypad, pointing device, etc.) 306 and a display screen 305, each coupled to be in communication with the processing unit 303.

The processing unit 303 may include an encoder/decoder 311 with an associated code Read Only Memory (ROM) 312 for storing data for encoding and decoding voice, data, control, or other signals that may be transmitted or received between other radios within direct mode communication range of radio 132. The processing unit 303 may further include a microprocessor 313 coupled, by the common data and address bus 317, to the encoder/decoder 311, a character ROM 314, a Random Access Memory (RAM) 304, and a static memory 316.

The communications unit 302 may include an RF interface 309 configurable to communicate directly with other direct mode radios such as radios, 112, 120, 122, and/or 130. The communications unit 302 may include one or more wireless transceivers 308, such as a DMR transceiver, an APCO P25 transceiver, a TETRA transceiver, a Bluetooth transceiver, a Wi-Fi transceiver perhaps operating in accordance with an IEEE 802.11 standard (e.g., 802.11a, 802.11b, 802.11g, 802.11n), a WiMAX transceiver perhaps operating in accordance with an IEEE 802.16 standard, and/or other similar type of wireless transceiver configurable to communicate via a wireless network. The transceiver 308 is also coupled to a combined modulator/demodulator 310 that is coupled to the encoder/decoder 311.

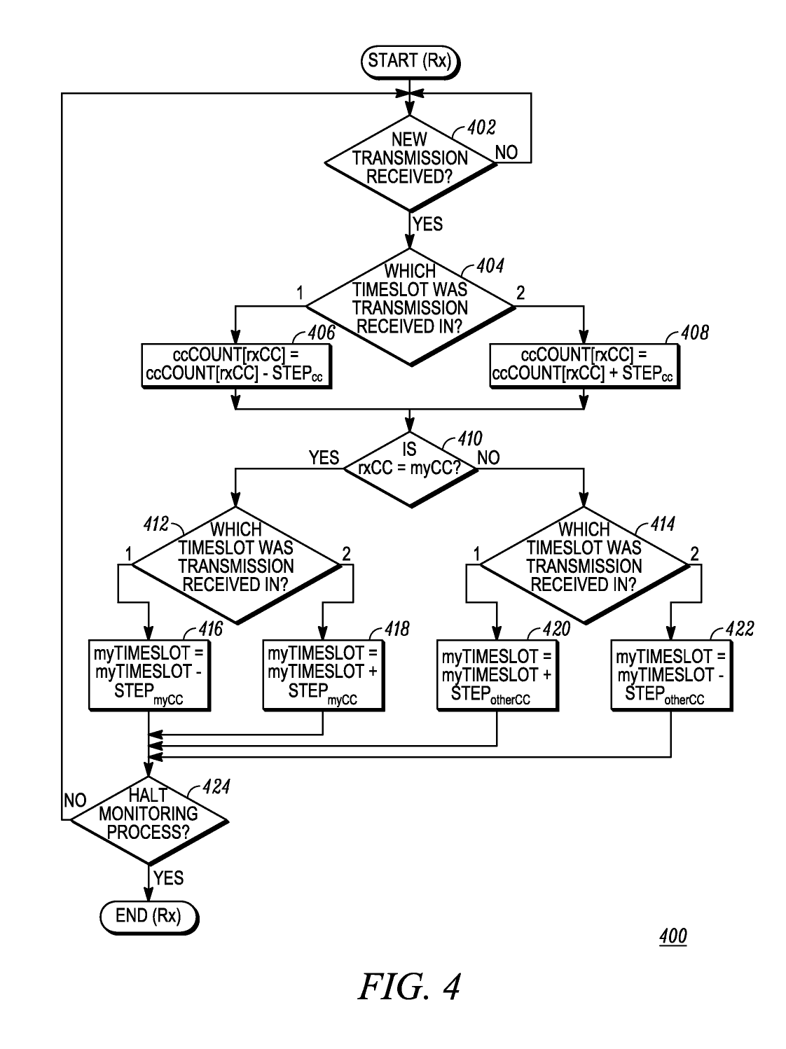

The microprocessor 313 has ports for coupling to the input unit 306 and to the display screen 305. The character ROM 314 stores code for decoding and/or encoding data such as control messages and/or data or voice messages that may be transmitted or received by the radio 132. Static memory 316 may store operating code for the microprocessor 313 that, when executed, monitors other radios' usage of a plurality of available timeslots on a direct mode radio frequency and, for each received new transmission, stores an indication of the timeslot used by the transmission and a system partitioning identifier associated with the transmission, dynamically determines, as a function of the monitoring, a first preferred transmit timeslot out of the plurality of available timeslots determined to be less likely to interfere with the other radios in the plurality of direct mode radios, responsive to detecting a request to transmit a new direct mode call, first determine if the first preferred transmit timeslot is available, and if so, transmit the new call in the first preferred transmit timeslot on the direct mode Radio Frequency, in accordance with one or more of FIGS. 4-7 and corresponding text. Static memory 316 may comprise, for example, a hard-disk drive (HDD), an optical disk drives such as a compact disk (CD) drive or digital versatile disk (DVD) drive, a solid state drive (SSD), a flash memory drive, or a tape drive, to name a few. Static memory 316 may further store information associated with monitoring and transmit timeslot selection processes set forth with respect to FIGS. 4-6, including but not limited to indications of timeslots, accumulators, variables, static threshold values, and/or partitioning identifiers.

A radio, as used herein, can be mobile and/or fixed equipment that is used to obtain radio services. For example, a radio can be a mobile radio (i.e. a portable radio, a mobile station, a subscriber unit, a mobile subscriber), or can be a fixed station (i.e. a fixed control station, a base station, and any supporting equipment such as consoles and/or packet data switches). Each radio is capable of communicating directly with one or more other radios using TDMA techniques as further described herein, in which specified time segments are divided into assigned timeslots for individual communications. Each radio frequency used by the radios in a direct mode communication system landscape carries timeslots whereby each timeslot out of a plurality of timeslots on the RF is known as a “channel.” A direct mode communication system landscape in which the radios operate may include a plurality of overlapping and/or non-overlapping direct mode communications systems across which one or more radio frequencies (and their channels) are thus shared amongst two or more groups of radios each assigned a particular system partitioning identifier.

For ease of describing the embodiments, hereinafter the wireless communications system 100 is presumed to be a two timeslot (2:1) TDMA shared RF communications system. Thus, in the embodiments described below, since there are two timeslots, there are two channels available on each radio frequency for carrying the traffic of the system. For example, in one embodiment, a timeslot has a length of thirty milliseconds (30 ms, including guard times) and is numbered “1” or “2”. It is important to note, however, that the TDMA communication system could equally have other slot lengths and slotting ratios as well. Thus, the present disclosure is applicable to any TDMA communication system that has a slotting ratio that is n:1, where n is an integer greater than 1, and where all direct mode radios are timeslot synchronized.

### II. DIRECT MODE RADIO DEVICE RECEIVE PROCESS

FIGS. 4-6 set forth example process flows for timeslot monitoring, preferred transmit timeslot selection, and new call transmission processes that may be executed at a direct mode radio in accordance with some embodiments. In the examples set forth in detail below, only particular sequences are disclosed with respect to the direct mode radio. Of course, additional steps not disclosed herein could be additionally added before, after, or in-between steps disclosed in FIGS. 4-6, and the presence of such additional steps would not negate the purpose and advantages of the examples set forth in detail throughout the remainder of this disclosure. Steps drawn with a dashed outline in FIGS. 4-6 should be understood to be optional steps.

While the disclosed process flows could be implemented for any type of slotting ratio parameter n:1 where n is greater than one and for any type of system partitioning identifier, the 2:1 slotting radio associated with the DMR standard and the color code system partitioning identifier associated with the DMR standard will be relied upon for ease of illustration and description in the remainder of this document. Under the DMR standard, and for example, a color code of “orange” (perhaps associated with a color code index of “1”) may be assigned to radios being used by one agency such as a policing agency, and a separate color code of “yellow” (perhaps associated with a color code index of “2”) assigned to radios being used by another agency such as a fire fighter agency that may be use nearby or in an overlapping manner with radios using the orange color code. Radios configured to use the orange color code would embed the color code (or its corresponding index) in its transmissions, process, decode, unmute, and/or display communications received from other radios with the orange color code (or its corresponding index) embedded in the communication, and refrain from processing, decoding, unmuting, and/or displaying communications received from other radios with the yellow color code (or its corresponding index) embedded in the communication. Other types of agencies, other types of system partitioning identifiers, and more or fewer color codes and/or agencies could be implemented as well.

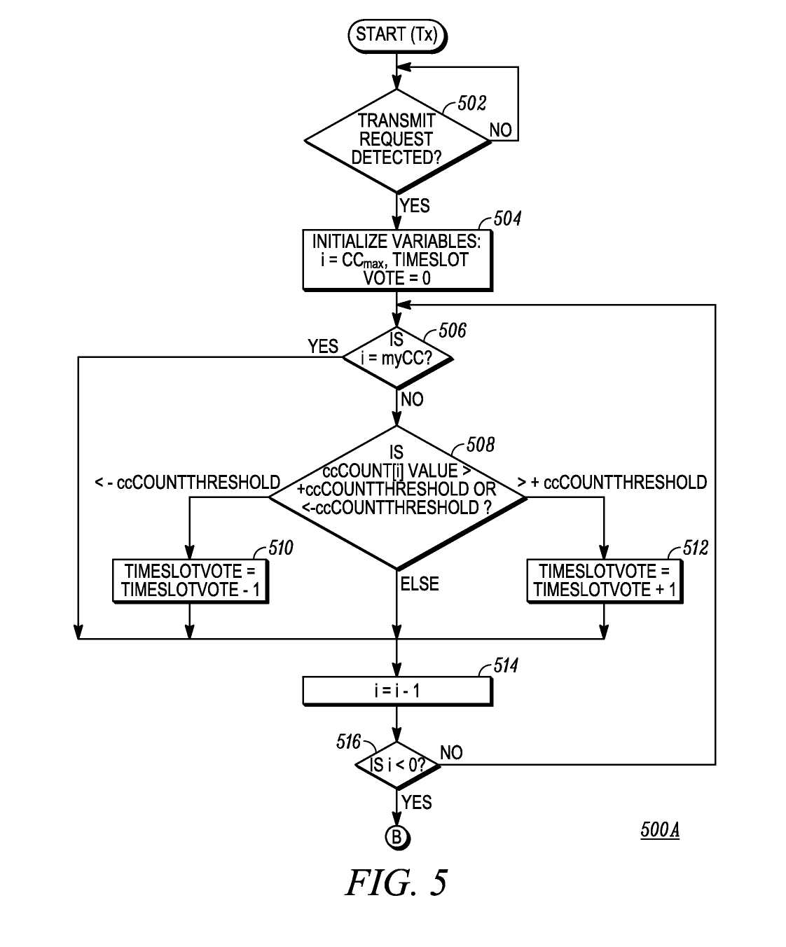

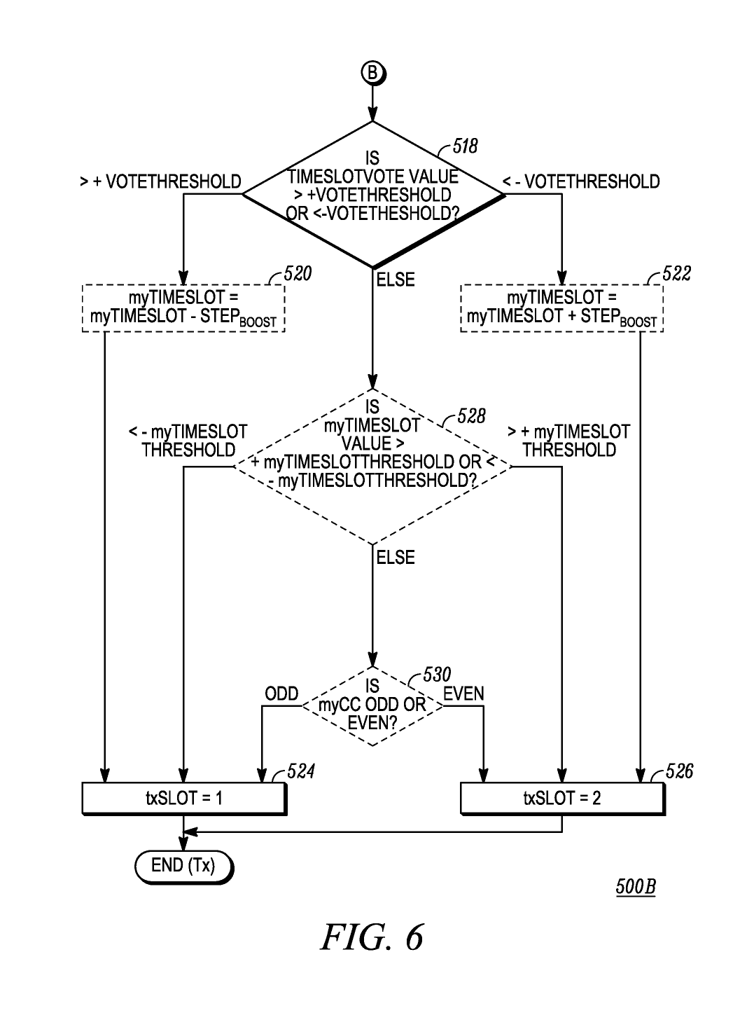

Further details regarding the process flows will be first set forth with regard to the timeslot monitoring process in FIG. 4 and the preferred transmit timeslot selection process in FIGS. 5-6, below.

FIG. 4 sets forth a method 400 executable at a direct mode radio such as radio 132 of FIGS. 1 and 3, for monitoring timeslot usage in a direct mode communication system in which the direct mode radio is operating. At step 402, a receiving direct mode radio detects a reception of a new transmission (e.g., a new voice call, data call, signaling packet, control packet, etc.), and further processes the transmission to determine at least a color code associated with the transmission and which timeslot the transmission was received in. A new transmission versus an ongoing transmission can be distinguished by the existence and/or contents of a header preceding subsequent call data in the transmission. In some embodiments, the direct mode radio may consider each new call a separate transmission, and only proceed from step 402 to step 404 when a new call is detected. In other embodiments, the direct mode radio may consider each reception in a timeslot as a separate transmission, regardless of whether it is part of a previously already-processed call, and may proceed from step 402 to step 404 for each timeslot that includes an active (new or old) transmission. For the purposes of the example set forth in FIG. 4, it is assumed that the direct mode radio only considers new transmissions.

The direct mode radio may further process the transmission at step 402 and at least determine a color code associated with the transmission. The color code may be specified in an EMB Field of a voice burst and/or in a Slot Type Field of a general data burst consistent with the ETSI TS 102 361-1 v2.1.1, April 2012 standard. The timeslot on which the transmission is received may be determined by a particular sync pattern detected in the received transmission, or via an internal timeslot timing process perhaps consistent with U.S. patent application Ser. No. 12/760,787, entitled “Method for Synchronizing Direct Mode Time Division Multiple Access (TDMA) Transmissions,” a process consistent with U.S. patent application Ser. No. 12/331,189, entitled “Method of Efficiently Synchronizing to a Desired Timeslot in a Time Division Multiple Access Communication System” (now U.S. Pat. No. 8,279,991), and a process consistent with U.S. patent application Ser. No. 12/331,137, entitled “Method of Communicating which Channel is to be Monitored by Subscriber Units that are Idle in a Communication System” (now U.S. Pat. No. 8,045,499), among other possibilities.

At step 404, the receiving direct mode radio determines whether the transmission was received in timeslot 1 or timeslot 2. If the transmission was received in timeslot 1, processing proceeds to step 406, where a particular color code identifier counter (ccCount[rxCC]) associated with the color code indicated in the received transmission (rxCC) is decremented by a predetermined step value (Step_{CC}), which may have a value of 1, 10, or 100, for example. On the other hand, if the transmission was received in timeslot 2, processing proceeds from step 404 to step 406, where the particular color code identifier counter ccCount[rxCC] associated with the color code indicated in the received transmission rxCC is incremented by the predetermined step value Step_{CC}. In this example, a positive value of the ccCount counter for any particular color code is associated with timeslot 2, while a negative value of the ccCount counter for any particular color code is associated with timeslot 1. Of course, the process could be reversed in another embodiment by switching the association between value and timeslot and switching the respective increment and decrement actions in steps 406 and 408. An example ccCount array may take the form as set forth in Table I:

TABLE I
Example ccCount Counter Array

| ccCount[ ] | ccCount[ ] | |
|---|---|---|
| Index | Assoc'd Color | Counter Value |
| 1 | “Yellow” | 10 |
| 2 | “Orange” | −9 |
| 3 | “Blue” | 0 |

The example ccCount counter array may be stored, retrieved, and maintained, for example, in a static or volatile memory such as static memory 316 in the direct mode radio. Other information used throughout the monitoring process 400 (and the transmit timeslot selection process 500A-B, for that matter), including indications of timeslots, accumulators, variables, static threshold values, and/or partitioning identifiers, may similarly be stored, retrieved, and maintained in the static or volatile memory at the direct mode radio.

As set forth in Table I, and for example, the ccCount counter for the yellow color code (index 1) may have a value of 10 and indicate that transmissions being monitored and received at the receiving direct mode radio and associated with the yellow color code tend to favor using timeslot 2. Specifically, and assuming a Step_{CC} value of 1, ten more transmissions associated with the color code yellow have used timeslot 2 than have used timeslot 1. On the other hand, the ccCount counter for the orange color code (index 2) may have a value of −9 and indicate that transmissions being monitored at the receiving direct mode radio and associated with the orange color code tend to favor using timeslot 1. Specifically, and assuming a Step_{CC} value of 1, nine more transmission associated with the color code yellow have used timeslot 1 than have used timeslot 2. In regard to the ccCount counter associated with the blue color code, either no transmission have been received associated with the blue color code, or perhaps an equal number of transmissions have been received associated with the blue color code that use timeslot 1 as use timeslot 2. In accordance with the foregoing, steps 402-408 keep track of all color codes (e.g., sets of system partitioned radios and co-channel users in communication range of the receiving direct mode radio) and attempts to figure out what timeslot most other co-channel sets of partitioned radios are using. This information can then be used in the transmit process, discussed in more detail below, to identify a preferred transmit timeslot as the timeslot being used by the fewest sets of co-channel partitioned radios within transmission range of the receiving direct mode radio.

Moving on to step 410, the receiving direct mode radio determines if the received color code rxCC matches the receiving direct mode radio's own color code (myCC). If rxCC=myCC, processing moves to step 412, where the receiving direct mode radio determines whether the transmission was received in timeslot 1 or timeslot 2. If the transmission was received in timeslot 1, processing proceeds to step 416, where an overall communication system landscape-wide timeslot counter (“myTimeslot,” representing an accumulated timeslot value of received transmissions using the direct mode radio's color code versus received transmissions using other than the direct mode radio's color code) is decremented by a predetermined step value (Step_{myCC}), which may have a value of 2, 20, or 200, for example. On the other hand, if the transmission was received in timeslot 2, processing proceeds from step 412 to step 418, where the overall communication system landscape-wide timeslot counter myTimeslot is incremented by the predetermined step value Step_{myCC}. Because the received transmission's color code is equal to the received direct mode radio's color code, the radio is configured to apply a relatively higher step value Step_{myCC} to push the direct mode radio towards using the same timeslot as other radios that are within transmission range of the direct mode radio and configured with the same color code.

Returning to step 410, if the received color code rxCC is not equal to the direct mode radio's own color code myCC (e.g., rxCC myCC), processing moves to step 414, where the receiving direct mode radio determines whether the transmission was received in timeslot 1 or timeslot 2. If the transmission was received in timeslot 1, processing proceeds to step 420, where the overall communication system landscape-wide timeslot counter myTimeslot is incremented by a predetermined step value (Step_{otherCC}), which may have a value of 1, 10, or 100, for example. On the other hand, if the transmission was received in timeslot 2, processing proceeds from step 414 to step 422, where the overall communication system landscape-wide timeslot counter myTimeslot is decremented by the predetermined step value Step_{otherCC}. Because the received transmission's color code is not equal to the received direct mode radio's color code, the radio is configured to apply a relatively lower step value Step_{otherCC} (compared to Step_{myCC}) to push the direct mode radio towards using the opposite timeslot as other radios within transmission range of the direct mode radio.

Processing proceeds from any one of steps 416, 418, 420, or 422 to step 424, where the receiving direct mode radio determines whether it should halt the timeslot monitoring process 400. For example, a battery conserving mode or an indicated power-off of the receiving direct mode radio may halt the timeslot monitoring process 400. Additionally or alternatively, another internal process in the receiving direct mode radio may halt the monitoring process (e.g., when it is involved in an active call) or an input selection by a user may halt the monitoring process. On the other hand, if no halting condition is detected at step 424, processing returns to step 402 where the receiving direct mode radio waits for a new transmission to be received.

In accordance with the foregoing, steps 410-424 keep track of overall timeslot use across all color codes and attempts to balance them out by strongly preferring to stay on a same timeslot as other direct mode radios assigned the same color code as the receiving direct mode radio, but also taking into consideration (albeit to a lesser extent) other direct mode radios' (e.g., that are assigned a different color code as the receiving direct mode radio) use of timeslots and tries to avoid the timeslot(s) used by other color codes.

### III. DIRECT MODE RADIO DEVICE TRANSMIT PROCESS

The information obtained in the monitoring process 400 can then be additionally used in a transmit process to identify a preferred transmit timeslot. FIGS. 5 and 6 illustrate a preferred transmit timeslot selection process 500A-500B that includes a majority vote determination (steps 504-526), and several optional backup selection processes (cumulative timeslot usage in step 528 and a provisioned selection in step 530) in the event the majority vote determination fails to yield a clear timeslot preference.

FIG. 5 sets forth a first partial method 500A executable at a direct mode radio such as radio 132 of FIGS. 1 and 3, for determining a preferred transmit timeslot, using information gained from the monitoring process 400 of FIG. 4. At step 502, the direct mode radio detects a transmit request. The transmit request could be detected as a result of a user's activation of an externally available input interface such as a button (push to talk button (PTT)), a touch surface, a voice activated function, or some other input. As another example, the transmit request could be generated internally by some other process, such as a GPS process desiring to transmit updated GPS coordinates to one or more other direct mode radios. Other possibilities exist as well. If no transmit request is detected, processing loops back to step 502. If a transmit request is detected, processing proceeds to step 504.

At step 504, the direct mode radio initializes internal variables including a step counter “i” that is initially set to the maximum number of color codes (CCₘₐₓ) available (detected or pre-configured) and including a TimeslotVote accumulator variable that is initialized to some pre-determined neutral value such as “0”. The step counter “i” is used in subsequent steps to move through the available color codes being tracked in the monitoring process of FIG. 4, and the TimeslotVote accumulator variable is used in subsequent steps to accumulate bias towards selecting a first of two timeslots to transmit on (either more positive or more negative) or a second of time timeslots to transmit on (the other of more positive or more negative). For example, in the process flow of FIG. 5, a more positive accumulated value for TimeslotVote (relative to the pre-determined neutral value of 0 in this example) is associated with selecting timeslot 1 as the preferred transmit timeslot because it was determined that the majority of other color codes are using timeslot 2, while a more negative accumulated value (relative to the pre-determined neutral value of 0 in this example) is associated with selecting timeslot 2 as the preferred transmit timeslot because it was determined that the majority of other color codes are using timeslot 1. Of course, in other examples, the association between positive and negative bias and timeslot 1 and timeslot 2 could be reversed.

After initializing variables at step 504, the process 500A moves to step 506, where it is determined whether the value of the current step counter “i” is equal to the direct mode radio's own color code (myCC). Because the radio is attempting to determine a best choice for the preferred transmit timeslot that interferes with a least number of other color codes operating in the direct mode radio's direct mode communication system, the direct mode radio modifies the TimeslotVote accumulator variable only for color codes other than the direct mode radio's own color code in steps 506-516. Accordingly, if it is determined at step 506 that the value of the current step counter “i” is equal to the direct mode radio's own color code myCC, processing proceeds directly to step 514, bypassing any modification of the TimeslotVote accumulator variable for the current value of step counter “i”. If, on the other hand, it is determined at step 506 that the value of the current step counter “i” is not equal to the direct mode radio's own color code myCC, processing proceeds to step 508.

At step 508, the direct mode radio compares the current value of the particular color code counter ccCount associated with the i^{th} color code (e.g., ccCount[i]), as set by the monitoring process 400 of FIG. 4, with a preconfigured threshold variable ccCountThreshold. The value of the preconfigured threshold variable ccCountThreshold is set to ensure that the radios associated with the i^{th} color code have at least appeared to have settled on a particular timeslot as a preferred transmit timeslot before it is counted in the TimeslotVote variable and is allowed to affect the direct mode radio's timeslot preference. In some embodiments, the value of ccCountThreshold may be set to 0, 1, 5, or 10, for example. If the current value of ccCount[i] is sufficiently less than the negative of ccCountThreshold (which, in this example, is associated with the i^{th} color code using timeslot 1 sufficiently more than timeslot 2), processing proceeds to step 510, where the value of TimeslotVote is decremented by some preconfigured value (for example, “1” as shown in FIG. 5) in order to bias the direct mode radio towards choosing timeslot 2 for the requested transmission.

However if, at step 508, the current value ccCount[i] is sufficiently more than the positive of ccCountThreshold (which, in this example, is associated with the i^{th} color code using timeslot 2 more than timeslot 1), processing proceeds to step 512, where the value of TimeslotVote is incremented by the same preconfigured value (for example, “1” as shown in FIG. 5) in order to bias the direct mode radio towards choosing timeslot 1 for the requested transmission. In those instances where the current value of ccCount[i] is not sufficiently determinative (e.g., is not less than the negative of ccCountThreshold and is not more than the positive of ccCountThreshold), processing drops directly down to 514, where the value of “i” is decremented without modifying the TimeslotVote variable. Furthermore, after corresponding decrementing or incrementing the TimeslotVote variable in steps 510 and 512, processing similarly proceeds to step 514, where the value of “i” is decremented after respectively modifying the TimeslotVote variable.

At step 516, the direct mode radio analyzes the current value of “i” to determine if each one of the color codes available has already been processed. In this example, and since “i” was set to CCₘₐₓ at step 504, the direct mode radio determines if “i” is less than 0 after the decrementing of step 514, and if not, returns to step 506 to operate on another available color code. On the other hand, if “i” is less than 0 after the decrementing of step 514, the direct mode radio moves on to process 500B in FIG. 6. Of course, in other embodiments, the value of “i” could be set to 0 at step 504, incremented at step 514, and compared to CCmax at step 516 to determine whether we progressed through each available color code, among other options.

Turning now to second partial method 500B in FIG. 6, continuing from method 500A of FIG. 5, the direct mode radio determines whether the majority vote calculation of steps 504-516 was sufficient to determine a preferred transmit timeslot for the direct mode radio and if so, chose it (steps 518-526), and if not, choose from one or more backup voting algorithms (steps 528-530).

More specifically, at step 518, the direct mode radio compares the current value of the TimeslotVote variable with a preconfigured threshold variable VoteThreshold. The value of VoteThreshold is set to ensure that the majority vote calculation of steps 504-516 resulted in a definitive determination that most color codes are using the first or second timeslot, accordingly. For example, the VoteThreshold may be 0, 1, or 5, and if the calculated value of the TimeslotVote variable does not exceed (negatively or positively) the corresponding negative or positive value of the VoteThreshold, we can determine that the other color codes within transmission range of the direct mode radio are choosing timeslot 1 and timeslot 2 in a somewhat equal manner, and we should move on to a different backup technique of determining a preferred transmit timeslot. If, however, the TimeslotVote variable exceeds the VoteThreshold in the positive direction (e.g., is more positive than the positive of the VoteThreshold variable), processing moves from step 518 to optional step 520, where the myTimeslot variable is boosted in the negative direction by the preconfigured value Step_{Boost} to more prefer timeslot 1 in the future, before moving on to step 524 and assigning timeslot 1 as the preferred transmit timeslot.

Somewhat similarly, if the TimeslotVote variable exceeds the negative VoteThreshold in the negative direction (e.g., is more negative than the negative of the VoteThreshold variable), processing moves from step 518 to optional step 522, where the myTimeslot variable is boosted in the positive direction by the preconfigured value Step_{Boost} to more prefer timeslot 2 in the future, before moving on to step 526 and assigning timeslot 2 as the preferred transmit timeslot.

Returning to step 518, in the event that the calculated value of the TimeslotVote variable does not exceed (negatively or positively) the corresponding negative or positive value of the VoteThreshold, processing may proceed to any one or more optional backup voting processes, including one of the two backup voting processes represented by steps 528 and 530 in FIG. 6. Other and different backup voting processes could be used as well.

The first optional backup voting process, at step 528, compares the current value of the communication system landscape-wide timeslot counter myTimeslot (representing an accumulated timeslot value of received transmissions using the direct mode radio's color code versus received transmission using a color code other than the direct mode radio's color code), as set by the monitoring process described with respect to FIG. 4 above, to a preconfigured threshold variable myTimeslotThreshold. The value of the preconfigured threshold variable myTimeslotThreshold, similar to the VoteThreshold variable, is set to ensure that the communication system landscape-wide cumulative timeslot vote calculation of steps 410-422 of FIG. 4 resulted in a definitive determination of which timeslot is preferred. For example, the myTimeslotThreshold may be 0, 1, or 5, and if the calculated value of the myTimeslot variable does not exceed (negatively or positively) the corresponding negative or positive value of the myTimeslotThreshold, the direct mode radio may conclude that the other transmissions in the direct mode radio's direct mode communication system are using timeslot 1 and timeslot 2 in a somewhat equal manner, and we should move on to a different backup technique of determining a preferred transmit timeslot. If, however, the myTimeslot variable exceeds the negative VoteThreshold in the negative direction (e.g., is more negative than the negative of the VoteThreshold variable), processing moves from step 518 to step 524, where timeslot 1 is assigned as the preferred transmit timeslot. If instead the myTimeslot variable exceeds the myTimeslotThreshold in the positive direction (e.g., is more positive than the positive of the VoteThreshold variable) at step 528, processing moves from step 528 to step 526, where timeslot 2 is assigned as the preferred transmit timeslot.

The second optional backup voting process, at step 530, uses a pre-provisioned voting process that is not dependent upon any of the statistics tracked in the monitoring process 400 of FIG. 4. In the example of FIG. 6, the direct mode radio determines if the direct mode radio's assigned color code identifier myCC is odd or even (e.g., each color code is assigned a corresponding index number, such that the color “yellow” may be color code 1, “orange” color code 2, “blue” color code 3, etc.). If the myCC identifier is determined to be odd, processing moves from step 530 to step 524, where timeslot 1 is assigned as the preferred transmit timeslot. If instead the myCC identifier is determined to be even, processing moves from step 530 to step 526, where timeslot 2 is assigned as the preferred transmit timeslot. Other statistically independent voting processes that are independent upon any of the statistics tracked in the monitoring process 400 of FIG. 4 could be used as well, including a random voting process, a pseudo-random voting process, and a deterministic voting process dependent upon some value other than the odd or even status of the direct mode radio's assigned color code identifier index myCC, such as the radio's hardware identifier, network ID, location, etc.

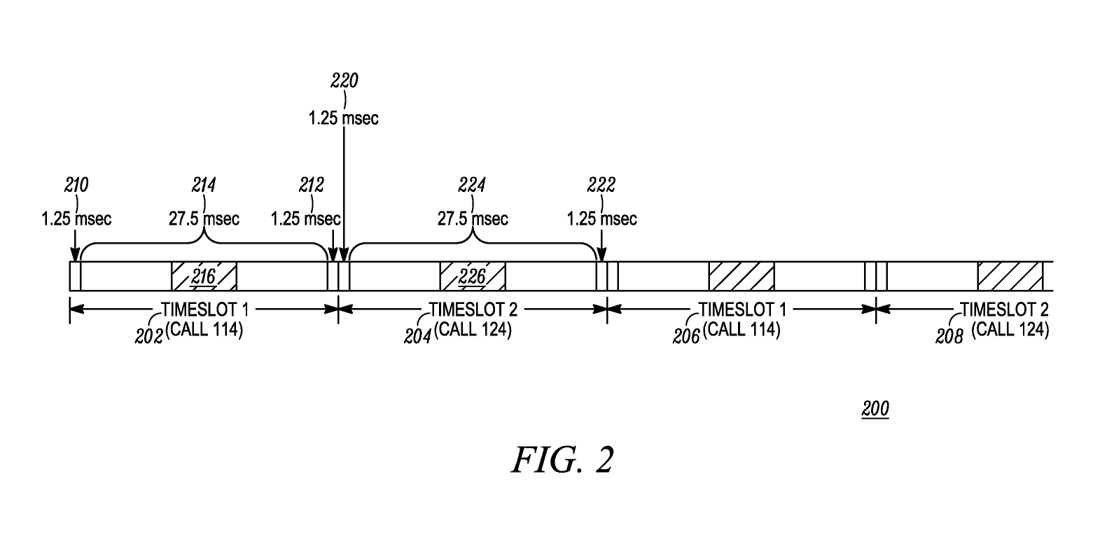

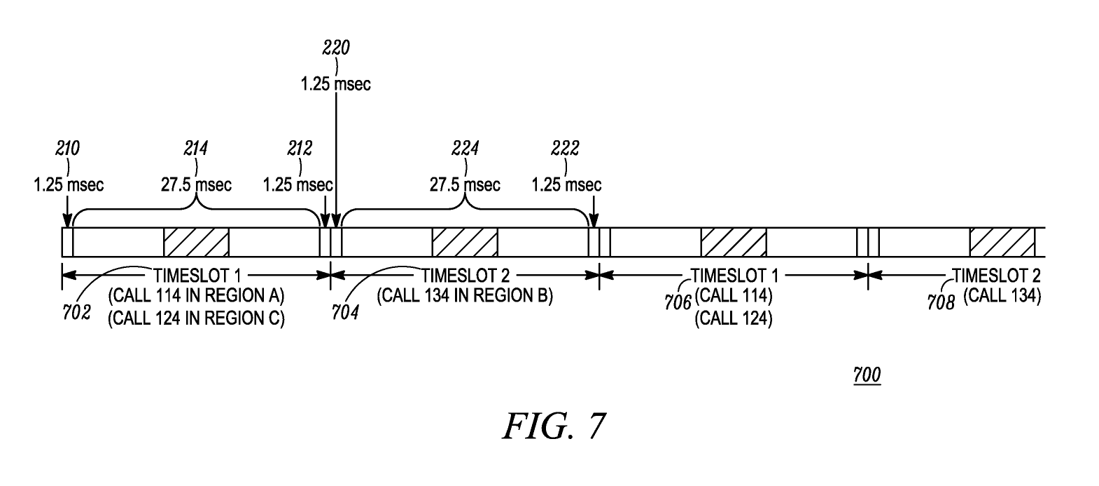

FIG. 7 illustrates an example resultant application of the voting processes set forth in FIGS. 4-7 on timeslot selection at a direct mode radio, relative to FIGS. 1 and 2. For example, radios 120 and 122, perhaps assigned a color code of “yellow” and operating within direct mode communication system C 106 may eventually be biased towards choosing timeslot 1, perhaps via the color code majority vote process of steps 404-408 and 504-516 of FIGS. 4 and 5 or via the timeslot cumulative vote process of steps 528 and 410-422 of FIGS. 4 and 5, and prefer timeslot 1 in future transmissions (while still being able to use timeslot 2 if it is available and timeslot 1 is not). Once radios 120 and 122 are biased towards timeslot 1 702, 706 in direct mode communication system C 106 (e.g., prefer to transmit on timeslot 1), radios 130 and 132 (perhaps assigned a color code of “orange” and operating in direct mode communication system B 104) will become biased towards timeslot 2 704, 708 in direct mode communication system B 104, and radios 110 and 112 (perhaps assigned a color code of “blue” and operating in direct mode communication system A 102) will become biased towards timeslot 1 702, 706 in direct mode communication system A 102, resulting in more efficient use of the 2:1 direct mode slotted TDMA communications resources as set forth in the timing diagram 700 of FIG. 7 and as compared to the timing diagram 200 of FIG. 2. Of course, depending on the amount of traffic and/or the first radio(s) to transmit, in another embodiment, radios 120 and 122 may become biased towards timeslot 2, radios 130 and 132 may become biased towards timeslot 1, and radios 110 and 112 may become biased towards timeslot 2. The result, however, is the same in that more efficient use of 2:1 direct mode slotted TDMA communications resources is obtained.

### IV. CONCLUSION

In accordance with the foregoing, an improved method for sharing synchronized direct mode TDMA timeslots among a plurality of radios by monitoring timeslot usage and dynamically determining a preferred transmit timeslot out of a plurality of available timeslots determined to be less likely to interfere with the other radios is disclosed. As a result, more efficient and adaptable use of available n:1 slotted TDMA communications resources amongst direct mode radios can be achieved without significant manual configuring of radios. Other advantages and benefits are possible as well.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method for sharing synchronized direct mode time division multiple access (TDMA) timeslots among a plurality of direct mode radios, the method comprising:
monitoring, by a first one of the plurality of direct mode radios, other radios' in the plurality of radios usage of a plurality of available timeslots on a direct mode radio frequency (RF) and, for each received new transmission received by the first radio on one of the available timeslots, storing an indication of the timeslot used by the new transmission and storing a system partitioning identifier associated with the new transmission;
dynamically determining, by the first radio and as a function of the monitoring, a first preferred transmit timeslot out of the plurality of available timeslots determined to be less likely to interfere with the other radios in the plurality of direct mode radios; and
responsive to detecting a request to transmit a new direct mode call, first determining if the first preferred transmit timeslot is available, and if the first preferred transmit timeslot is available, transmitting the new call in the first preferred transmit timeslot on the direct mode RF.

2. The method of claim 1, further comprising, second, if the first preferred transmit timeslot is not available, determining if another non-preferred transmit timeslot in the plurality of timeslots is available, and if so, transmitting the new call on the non-preferred transmit timeslot on the direct mode RF.

3. The method of claim 2, further comprising, responsive to detecting the request to transmit, third, and if the first preferred transmit timeslot is not available and the another non-preferred transmit timeslot is not available, refraining from transmitting the new call and providing an indication regarding the lack of an available channel over which to transmit the new call.

4. The method of claim 1, wherein the step of monitoring further comprises:
modifying a plurality of system partitioning identifier-specific timeslot counters relative to the number of received new transmissions including respective system partitioning identifiers in order to determine which timeslot each set of partitioned radios is using most often; and
modifying a communication system landscape-wide timeslot counter relative to the number of received new transmissions regardless of system partitioning identifier in order to determine overall timeslot usage.

5. The method of claim 4, wherein determining the first preferred transmit timeslot comprises:
determining whether the plurality of system partitioning identifier-specific timeslot counters sufficiently distinguish which of at least two timeslots to prefer, and if so, identifying the first preferred transmit timeslot as a function of the plurality of system partitioning identifier-specific timeslot counters, and if not, identifying the first preferred transmit timeslot as a function of the communication system landscape-wide timeslot counter.

6. The method of claim 1, wherein the step of monitoring further comprises:
for each received new transmission, identifying a second particular system partitioning identifier included in the new transmission, and if the received new transmission is transmitted on a first timeslot of two available timeslots, one of incrementing and decrementing a system partitioning identifier-specific timeslot counter associated with the second particular system partitioning identifier, and if the received new transmission is transmitted on a second timeslot of two available timeslots, the other of incrementing and decrementing the system partitioning identifier-specific timeslot counter associated with the second particular system partitioning identifier.

7. The method of claim 6, wherein the step of monitoring further comprises:
for each received new transmission, determining if the second particular system partitioning identifier matches the particular system partitioning identifier assigned to the first radio;
if the determination is that the received second particular system partitioning identifier matches the first radio's assigned particular system partitioning identifier:
if the received new transmission is transmitted on a first timeslot of two available timeslots, the other of incrementing and decrementing the a communication system landscape-wide timeslot counter not associated with any particular system partitioning identifier by a predetermined matching system partitioning identifier step value, and
if the received new transmission is transmitted on a second timeslot of two available timeslots, the one of incrementing and decrementing the communication system landscape-wide timeslot counter by the predetermined matching system partitioning identifier step value; and
if the determination is that the received second particular system partitioning identifier does not match the first radio's assigned particular system partitioning identifier:
if the received new transmission is transmitted on a first timeslot of two available timeslots, the one of incrementing and decrementing the communication system landscape-wide timeslot counter by a predetermined non-matching system partitioning identifier step value, and
if the received new transmission is transmitted on a second timeslot of two available timeslots, the other of incrementing and decrementing the communication system landscape-wide timeslot counter by the predetermined non-matching system partitioning identifier step value.

8. The method of claim 7, wherein the received second particular system partitioning identifier and the first radio's assigned particular system partitioning identifier are color codes.

9. The method of claim 7, wherein the predetermined non-matching system partitioning identifier step value is different from the predetermined matching system partitioning identifier step value.

10. The method of claim 7, wherein the monitoring step is executed over a plurality of received new transmissions received from a plurality of different radios out of the plurality of radios.

11. The method of claim 7, wherein determining a first preferred transmit timeslot comprises:
for each of a plurality of system partitioning identifier-specific timeslot counters each associated with a different corresponding particular system partitioning identifier, except for the system partitioning identifier-specific timeslot counter associated with the system partitioning identifier assigned to the first radio, comparing the system partitioning identifier-specific timeslot counter to a first predetermined value to determine if a group of radios using the system partitioning identifier associated with the partitioning identifier-specific timeslot counter is using the first timeslot more often than the second timeslot and if so, the other of incrementing and decrementing a voting counter, and if not, the one of incrementing and decrementing the voting counter;
comparing the voting counter to a second predetermined value to determine if the voting counter is sufficiently determinative of timeslot use by radios assigned system partitioning identifiers different from the first radio, and if so, identifying the first timeslot as the first preferred transmit timeslot if the voting counter is sufficiently greater than the second predetermined value, and if not, identifying the second timeslot as the first preferred transmit timeslot.

12. The method of claim 11, wherein if the voting counter is not sufficiently determinative of timeslot use:
comparing the communication system landscape-wide timeslot counter to a third predetermined value to determine if the communication system landscape-wide timeslot counter is sufficiently determinative of timeslot use, and if so, identifying the second timeslot as the first preferred transmit timeslot if the communication system landscape-wide timeslot counter is sufficiently greater than the third predetermined value, and if not, identifying the first timeslot as the first preferred transmit timeslot.

13. The method of claim 12, wherein if the voting counter and communication system landscape-wide timeslot counter are both not sufficiently determinative of timeslot use:
identifying the first timeslot as the first preferred transmit timeslot if the particular system partitioning identifier assigned to the first radio is one of odd and even, and identifying the second timeslot as the first preferred transmit timeslot if the particular system partitioning identifier assigned to the first radio is the other of odd and even.

14. A direct mode radio for synchronizing direct mode time division multiple access (TDMA) timeslots among a plurality of other direct mode radios, the direct mode radio configured to:
monitor the other direct mode radios' usage of a plurality of available timeslots on a direct mode radio frequency (RF) and, for each received new transmission received by the first radio on one of the available timeslots, store an indication of the timeslot used by the new transmission and store a system partitioning identifier associated with the new transmission;
dynamically determine as a function of the monitoring a first preferred transmit timeslot out of the plurality of available timeslots determined to be less likely to interfere with the other radios in the plurality of direct mode radios; and
responsive to detecting a request to transmit a new direct mode call, first determine if the first preferred transmit timeslot is available, and if the first preferred transmit timeslot is available, transmit the new call in the first preferred transmit timeslot on the direct mode RF.

15. The direct mode radio of claim 14, further configured to, second, if the first preferred transmit timeslot is not available, determine if another non-preferred transmit timeslot in the plurality of timeslots is available, and if so, transmit the new call on the non-preferred transmit timeslot on the direct mode RF.

16. The direct mode radio of claim 15, further configured to, if the first preferred transmit timeslot is not available and the another non-preferred transmit timeslot is not available, refrain from transmitting the new call and provide an indication regarding the lack of an available channel over which to transmit the new call.

17. The direct mode radio of claim 14, wherein the direct mode radio configured to monitor the other direct mode radios' usage of a plurality of available timeslots on a direct mode radio frequency RF comprises the direct mode radio configured to:
modify a plurality of system partitioning identifier-specific timeslot counters relative to the number of received new transmissions including respective system partitioning identifiers in order to determine which timeslot each set of partitioned radios is using most often; and
modify a communication system landscape-wide timeslot counter relative to the number of received new transmissions regardless of system partitioning identifier in order to determine overall timeslot usage.

18. The direct mode radio of claim 17, wherein the direct mode radio is configured to determine the first preferred transmit timeslot by:
determining whether the plurality of system partitioning identifier-specific timeslot counters sufficiently distinguish which of at least two timeslots to prefer, and if so, identifying the first preferred transmit timeslot as a function of the plurality of system partitioning identifier-specific timeslot counters, and if not, identifying the first preferred transmit timeslot as a function of the communication system landscape-wide timeslot counter.

19. The direct mode radio of claim 14, wherein the direct mode radio configured to monitor the other direct mode radios' usage of a plurality of available timeslots on a direct mode radio frequency RF comprises the direct mode radio configured to:
for each received new transmission, identify a second particular system partitioning identifier included in the new transmission, and if the received new transmission is transmitted on a first timeslot of two available timeslots, one of increment and decrement a system partitioning identifier-specific timeslot counter associated with the second particular system partitioning identifier, and if the received new transmission is transmitted on a second timeslot of two available timeslots, the other of increment and decrement the system partitioning identifier-specific timeslot counter associated with the second particular system partitioning identifier.

20. The direct mode radio of claim 19, wherein the direct mode radio configured to monitor the other direct mode radios' usage of a plurality of available timeslots on a direct mode radio frequency RF comprises the direct mode radio configured to:
for each received new transmission, determine if the second particular system partitioning identifier matches the particular system partitioning identifier assigned to the first radio;
if the determination is that the received second particular system partitioning identifier matches the first radio's assigned particular system partitioning identifier:
if the received new transmission is transmitted on a second timeslot of two available timeslots, one of increment and decrement the communication system landscape-wide timeslot counter by the predetermined matching system partitioning identifier step value; and
if the received new transmission is transmitted on a first timeslot of two available timeslots, the other of increment and decrement a communication system landscape-wide timeslot counter not associated with any particular system partitioning identifier by a predetermined matching system partitioning identifier step value, and
if the determination is that the received second particular system partitioning identifier does not match the first radio's assigned particular system partitioning identifier:
if the received new transmission is transmitted on a first timeslot of two available timeslots, the one of increment and decrement the communication system landscape-wide timeslot counter by a predetermined non-matching system partitioning identifier step value, and
if the received new transmission is transmitted on a second timeslot of two available timeslots, the other of increment and decrement the communication system landscape-wide timeslot counter by the predetermined non-matching system partitioning identifier step value.
